(19) United States
(12) Patent Application Publication
(10) Pub. No.: US 2024/0022658 A1
(43) Pub. Date: Jan. 18, 2024

(54) Instigating Communication

(71) Applicant: Supra (UK) Limited, Bromsgrove, Worcestershire (GB)

(72) Inventor: David Lee Ogden, Worcester, Worcestershire (GB)

(21) Appl. No.: 18/267,823

(22) PCT Filed: Dec. 17, 2021
(86) PCT No.: PCT/GB2021/053368

§ 371 Date: Jun. 16, 2023

(30) Foreign Application Priority Data
Dec. 18, 2020 (GB) 2020144.8

(51) Int. Cl. H04M 1/724; H04W 76/10; G06V 10/94; G06V 20/10

(52) U.S. Cl. CPC H04M 1/724; H04W 76/10; G06V 10/95; G06V 20/176; H04M 2250/52

(57) ABSTRACT

A method of instigating communication between a first party and a second party, the first party having a mobile communication device and a camera, comprising: the mobile communication device capturing at least one image of at least part of a building with the camera; querying a database of buildings, the database having entries, each entry relating to a building and including data relating to the visual appearance of the at least part of the building and contact information for a second party, the querying acting to compare the at least one image of the building with the data relating to the visual appearance of buildings in the database, determining whether the querying results in at least one match with the visual appearance of buildings in the database, if so, setting up a communication channel using the mobile telecommunications device to a second party indicated by the at least one match.

### CROSS-REFERENCE TO RELATED APPLICATION(S)

This present application is a United States National Stage Application of International Patent Application No. PCT/GB2021/053368, filed Dec. 17, 2021, which claims priority to United Kingdom Application No. 2020144.8, filed Dec. 18, 2020, the entire disclosures of both of which are hereby incorporated by reference.

### TECHNICAL FIELD

This disclosure relates to a method of, and a system for, instigating communication between a first party and a second party.

### BACKGROUND

Intercoms, both audio-only and including video, are known for allowing an occupant of a building to vet visitors to their building. Initially, they required dedicated terminals, one at the entrance to the building for the visitor to engage with, and another within the building. This meant that the occupant could only answer a visitor when they were in the building and free to move to wherever in the building the internal terminal was.

This has at least partially been ameliorated by systems such as the AMAZON RING doorbell, which provides a fixed external terminal, but can set up a video and audio channel to any suitable device connected to the internet. However, this still requires the external fixed terminal.

It has been proposed in such documents as French patent application FR3057124 and US patent application US2016/007820 to make use of two-dimensional barcodes (“QR-codes”) to set up communication between the mobile telephone of a visitor and the occupant of a building, wherever they may be. The visitor scans the two-dimensional barcode (typically using an application on their device and the device's camera), which then opens a communication channel with the occupant. This requires the two-dimensional barcode to be affixed to the building, which may be unsightly or even not permitted by building owners (where the occupant is a tenant) or local planning or zoning regulations.

### SUMMARY

According to a first aspect of the invention, there is provided a method of instigating communication between a first party and a second party, the first party having a mobile communication device having mobile connectivity functionality and a camera, comprising:
the mobile communication device capturing at least one image of at least part of a building with the camera;
the mobile communication device querying, using the mobile connectivity functionality, a database of buildings, the database having a plurality of entries, each entry relating to a building and including data relating to the visual appearance of the at least part of the building and contact information for a second party, the querying acting to compare the at least one image of the building with the data relating to the visual appearance of buildings in the database,
determining whether the querying results in either at least one match with the visual appearance of buildings in the database or with zero matches
if the querying results in at least one match, setting up a communication channel using the mobile telecommunications device to a second party indicated by the at least one match.

As such, rather than having to display some kind of indicia on a building, the building itself can serve as an identifying feature. This means that there is no longer the need for a building occupant to place anything on their building.

The data relating to the visual appearance of the building may comprise an image of the building; as such, the querying may comprise a comparison of the image of the building captured by the mobile communication device with a comparison the of the image of the building from the data relating to the visual appearance of the building. However, that will not account for, for example, the relative positions at which the two images of the building are captured.
As such, the data relating to the visual appearance of the building may comprise a representation of visible features of at least part of the building. As such, the method may comprise generating, typically using the mobile communication device, a representation of visible features of at least part of the building from the image captured by the mobile communication device. The querying may then comprise comparing the representation of visible features from the data relating to the visual appearance of the building and from the captured image.

Typically, each representation of visible features may represent parametrically the visible features; typically, the representations of visible features may be generated using a feature recognition algorithm on an image of at least part of the building (typically the image captured by the mobile communication device or an image captured for the purpose of generating the data relating to the visual appearance of the building).

The database may be stored on a server; the step of querying the database may comprise transmitting a query from the mobile communication device to the server over a network, such as the Internet. The server may be arranged to carry out the step of comparing the at least one image of the building with the data relating to the visual appearance of buildings in the database.

The method may comprise the determination by the mobile communication device of its position; in such a case, each entry in the database may include the position of the building, and the querying may additionally comprise comparing the position of the mobile communication device with the position of the building in the database. As such, the position of the mobile communication device may be used to check whether the match from the comparison of the captured image is correct.

The querying may comprise only carrying out the step of comparing the at least one image of the building with the data relating to the visual appearance of buildings in the database for entries that meet a criterion depending on the position of the mobile communication device. The criterion will typically be that the distance between the position of the mobile communication device and the position of the building in the database is less than a threshold. This therefore reduces the number of (potentially relatively computationally intensive) comparisons that need to be made, whilst still allowing for the measurement of position to have some inaccuracy.

The measurement of position may be from a positioning system, typically a radionavigation-satellite service (RNSS), such as the Global Positioning System (GPS), Differential GPS (DGPS), Galileo or GLONASS (Global Navigation Satellite System). Such systems are typically accurate to within a few metres even in perfect situations; in urban areas shadowing and reflection off buildings can reduce accuracy further. As such, by themselves such systems will not always be sufficiently accurate to reliably distinguish between close-by locations. However, by combining the database of the current invention with position sensing, the position sensing can be synergistically used to make particularly efficient use of the database.

The method may comprise the mobile communication device sensing local wireless communication networks, and each entry in the database may include any wireless communication networks which can be sensed at the building; the step of querying may comprise determining whether there is a match between any sensed local wireless communication networks and the wireless communication networks indicated in the database. For example, the mobile communication device may sense local Wi-Fi (IEEE 802.11) networks, and as part of the querying use the Service set identification (SSID) to determine whether there is a match between SSIDs sensed by the mobile communication device and those indicated in the database for a given building.

The image captured by the mobile communication device, and the data relating to the visual appearance of the at least part of the building may both relate to any part of a building, be it an entrance (pedestrian, vehicular or otherwise), a door, a gateway, an apartment or other subdivision of the building or the like.

Typically, the mobile communication device will be provided with an application to carry out the actions of the mobile communication device. This is convenient for the end user.

The communication channel may comprise a two-way voice channel and may include a video channel in at least one direction (first party to second party or vice versa).

According to a second aspect of the invention, there is provided a network for instigating communication between a first party and a second party, comprising:
the mobile communication device for the first party and having mobile connectivity functionality and a camera,
a server holding a database of buildings, the database having a plurality of entries, each entry relating to a building and including data relating to the visual appearance of the at least part of the building and contact information for a second party,
the mobile communication device being connected to the mobile communication device through a communication network;
the mobile communication device being arranged to:
capture at least one image of at least part of a building with the camera;
query, the database over the network so as to compare the at least one image of the building with the data relating to the visual appearance of buildings in the database,
determine whether the querying results in either at least one match with the visual appearance of buildings in the database or with zero matches
if the querying results in at least one match, set up a communication channel using the to a second party indicated by the at least one match.

As such, rather than having to display some kind of indicia on a building, the building itself can serve as an identifying feature. This means that there is no longer the need for a building occupant to place anything on their building.

The data relating to the visual appearance of the building may comprise an image of the building; as such, the querying may comprise a comparison of the image of the building captured by the mobile communication device with a comparison the of the image of the building from the data relating to the visual appearance of the building. However, that will not account for, for example, the relative positions at which the two images of the building are captured.

As such, the data relating to the visual appearance of the building may comprise a representation of visible features of at least part of the building. As such, the mobile communication device may be arranged to generate, a representation of visible features of at least part of the building from the image captured by the mobile communication device. The querying may then comprise comparing the representation of visible features from the data relating to the visual appearance of the building and from the captured image.

Typically, each representation of visible features may represent parametrically the visible features; typically, the representations of visible features may be generated using a feature recognition algorithm on an image of at least part of the building (typically the image captured by the mobile communication device or an image captured for the purpose of generating the data relating to the visual appearance of the building).

The mobile communication device may have a position sensor and each entry in the database may include the position of the building; the querying may additionally comprise comparing the position of the mobile communication device determined by the position sensor with the position of the building in the database. As such, the position of the mobile communication device may be used to check whether the match from the comparison of the captured image is correct.

The querying may comprise only carrying out the step of comparing the at least one image of the building with the data relating to the visual appearance of buildings in the database for entries that meet a criterion depending on the position of the mobile communication device. The criterion will typically be that the distance between the position of the mobile communication device and the position of the building in the database is less than a threshold. This therefore reduces the number of (potentially relatively computationally intensive) comparisons that need to be made, whilst still allowing for the measurement of position to have some inaccuracy.

The measurement of position by the position sensor may be from a positioning system, typically a radionavigation-satellite service (RNSS), such as the Global Positioning System (GPS), Differential GPS (DGPS), Galileo or GLONASS (Global Navigation Satellite System). Such systems are typically accurate to within a few metres even in perfect situations; in urban areas shadowing and reflection off buildings can reduce accuracy further. As such, by themselves such systems will not always be sufficiently accurate to reliably distinguish between close-by locations. However, by combining the database of the current invention with position sensing, the position sensing can be synergistically used to make particularly efficient use of the database.

The mobile communication device may have a receiver for wireless communication networks, and each entry in the database may include any wireless communication networks which can be sensed at the building; the step of querying may comprise determining whether there is a match between any local wireless communication networks sensed by the mobile communication device and the wireless communication networks indicated in the database. For example, the mobile communication device may sense local WiFi (IEEE 802.11) networks, and as part of the querying use the Service set identification (SSID) to determine whether there is a match between SSIDs sensed by the mobile communication device and those indicated in the database for a given building.

The image captured by the mobile communication device, and the data relating to the visual appearance of the at least part of the building may both relate to any part of a building, be it an entrance (pedestrian, vehicular or otherwise), a door, a gateway, an apartment or other subdivision of the building or the like.

Typically, the mobile communication device will be provided with an application to carry out the actions of the mobile communication device. This is convenient for the end user.

The communication channel may comprise a two-way voice channel and may include a video channel in at least one direction (first party to second party or vice versa).

According to a third aspect of the invention, there is provided a mobile communication device for instigating communication between a first party and a second party, having mobile connectivity functionality and a camera,
the mobile communication device being able to connect using the mobile connectivity functionality to a server holding a database of buildings, the database having a plurality of entries, each entry relating to a building and including data relating to the visual appearance of the at least part of the building and contact information for a second party,
the mobile communication device being arranged to:
capture at least one image of at least part of a building with the camera;
query, the database over the network so as to compare the at least one image of the building with the data relating to the visual appearance of buildings in the database,
determine whether the querying results in either at least one match with the visual appearance of buildings in the database or with zero matches
if the querying results in at least one match, set up a communication channel using the to a second party indicated by the at least one match.

As such, rather than having to display some kind of indicia on a building, the building itself can serve as an identifying feature. This means that there is no longer the need for a building occupant to place anything on their building.

The data relating to the visual appearance of the building may comprise an image of the building; as such, the querying may comprise a comparison of the image of the building captured by the mobile communication device with a comparison the of the image of the building from the data relating to the visual appearance of the building. However, that will not account for, for example, the relative positions at which the two images of the building are captured.

As such, the data relating to the visual appearance of the building may comprise a representation of visible features of at least part of the building. As such, the mobile communication device may be arranged to generate, a representation of visible features of at least part of the building from the image captured by the mobile communication device. The querying may then comprise comparing the representation of visible features from the data relating to the visual appearance of the building and from the captured image.

Typically, each representation of visible features may represent parametrically the visible features; typically, the representations of visible features may be generated using a feature recognition algorithm on an image of at least part of the building (typically the image captured by the mobile communication device or an image captured for the purpose of generating the data relating to the visual appearance of the building).

The mobile communication device may have a position sensor and each entry in the database may include the position of the building; the querying may additionally comprise comparing the position of the mobile communication device determined by the position sensor with the position of the building in the database. As such, the position of the mobile communication device may be used to check whether the match from the comparison of the captured image is correct.

The querying may comprise only carrying out the step of comparing the at least one image of the building with the data relating to the visual appearance of buildings in the database for entries that meet a criterion depending on the position of the mobile communication device. The criterion will typically be that the distance between the position of the mobile communication device and the position of the building in the database is less than a threshold. This therefore reduces the number of (potentially relatively computationally intensive) comparisons that need to be made, whilst still allowing for the measurement of position to have some inaccuracy.

The measurement of position by the position sensor may be from a positioning system, typically a radionavigation-satellite service (RNSS), such as the Global Positioning System (GPS), Differential GPS (DGPS), Galileo or GLONASS (Global Navigation Satellite System). Such systems are typically accurate to within a few metres even in perfect situations; in urban areas shadowing and reflection off buildings can reduce accuracy further. As such, by themselves such systems will not always be sufficiently accurate to reliably distinguish between close-by locations. However, by combining the database of the current invention with position sensing, the position sensing can be synergistically used to make particularly efficient use of the database.

The mobile communication device may have a receiver for wireless communication networks, and each entry in the database may include any wireless communication networks which can be sensed at the building; the step of querying may comprise determining whether there is a match between any local wireless communication networks sensed by the mobile communication device and the wireless communication networks indicated in the database. For example, the mobile communication device may sense local WiFi (IEEE 802.11) networks, and as part of the querying use the Service set identification (SSID) to determine whether there is a match between SSIDs sensed by the mobile communication device and those indicated in the database for a given building.

The image captured by the mobile communication device, and the data relating to the visual appearance of the at least part of the building may both relate to any part of a building, be it an entrance (pedestrian, vehicular or otherwise), a door, a gateway, an apartment or other subdivision of the building or the like.

Typically, the mobile communication device will be provided with an application to carry out the actions of the mobile communication device. This is convenient for the end user.

The communication channel may comprise a two-way voice channel and may include a video channel in at least one direction (first party to second party or vice versa).

According to a fourth aspect of the invention, there is provided a computer-readable medium carrying computer executable instructions which, when executed on a processor of a mobile communication device, cause it to act as the mobile communication device of the first or third aspects of the invention.

### BRIEF DESCRIPTION OF THE DRAWINGS

There now follows, by way of example only, description of an embodiment of the invention described with reference to the accompanying drawings, in which:

FIG. 1 shows schematically a system in accordance with an embodiment of the invention;

FIG. 2 shows the external functions of a mobile communication device for use in the system of FIG. 1;

FIG. 3 shows the internal functions of the mobile communication device of FIG. 2;

FIG. 4 shows the internal functions of a server for use in the embodiment of FIG. 1;

FIG. 5 shows the contents of a database stored on the server of the FIG. 4;

FIG. 6 shows a sample image as captured by the mobile communication device of FIG. 2;

FIG. 7 shows the image of FIG. 6, once feature recognition has been carried out;

FIG. 8 shows the features extracted from FIG. 6; and

FIG. 9 shows a flowchart showing the method carried out by the system of FIG. 1.

### DETAILED DESCRIPTION

In accordance with an embodiment of the invention, the accompanying drawings show a system that can be used to establish communication between two parties, typically first party visiting a building and a second party being an occupant, or otherwise associated with, the building. Herein, “building” can include any part of a building, internal or external, be it an entrance (pedestrian, vehicular or otherwise), a door, a gateway, an apartment or other subdivision of the building or the like.

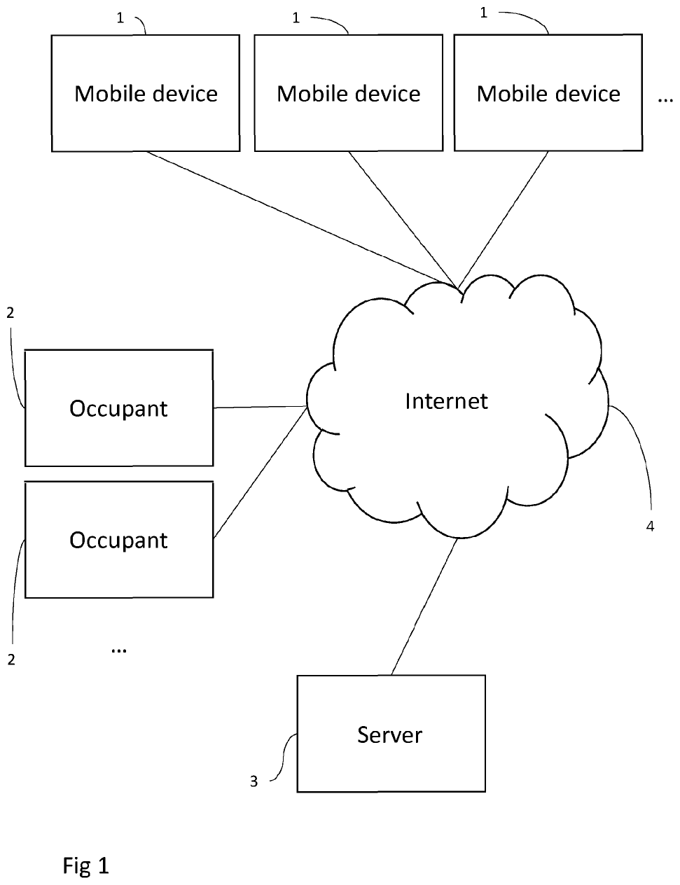

FIG. 1 of the accompanying drawings shows schematically the whole system used in this embodiment. There are any number of mobile communication devices (hereafter mobile devices 1) which connect through a network (here the internet 4) to a server 3. The system further comprises a plurality of occupant terminals 2, which will typically also be mobile communication devices, connected through the Internet 4 to the server 3. As will be explained in more detail below, the server 3 acts to connect mobile devices 1 to occupant terminals 2 on demand.

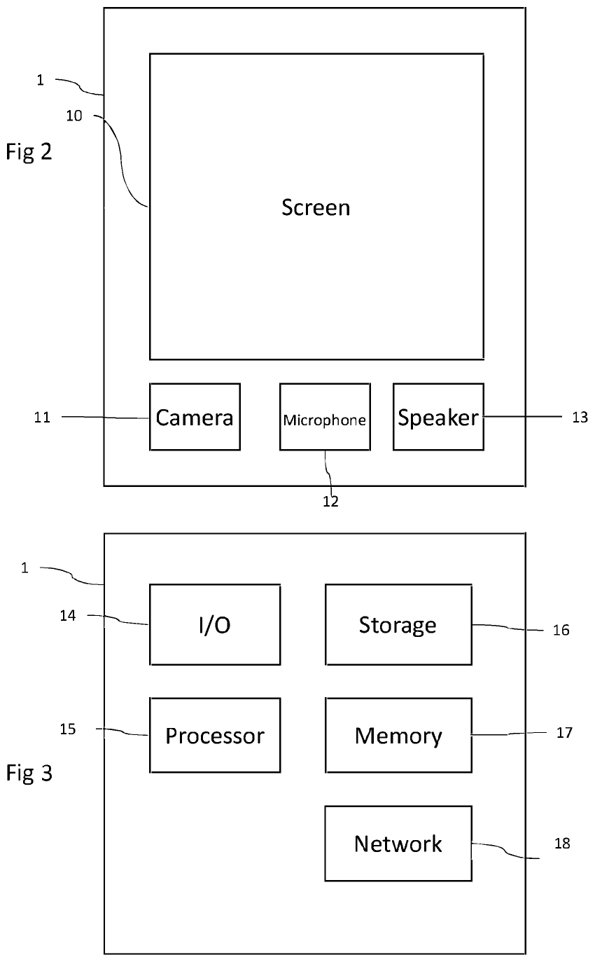

FIGS. 2 and 3 of the accompanying drawings show the functionality of the mobile devices 1 in more detail, with FIG. 2 showing the external functionality and FIG. 3 showing the internal functionality. Each mobile device 1 will typically be a smartphone (such as the Apple iPhone® or Samsung Galaxy®) on which applications can be loaded.

As such, each mobile device 1 will have externally a screen 10 on which data can be displayed to a user, a camera 11 by means of which images of the user's surroundings can be captured, a microphone by means of which sounds emanating from the user's surroundings can be captured, and a speaker 13 for generating sounds.

Each mobile device 1 will also have internally storage 16 (such as flash, or other non-volatile, random access memory/RAM) and memory 17 (such as random access memory RAM) a processor 15 for executing computer code stored in the storage 16 or memory 17, an input/output controller 14 for communication with the external components discussed above, and a network controller 18 for controlling the mobile connectivity functions of the mobile device 1.

In this embodiment, the mobile device 1 will be capable of communication via at least fourth generation broadband cellular networks (“4G” or long term evolution “LTE”) and wireless local access networks such as WiFi (Institute of Electrical and Electronics Engineers standard IEEE 802.11) or Bluetooth® (IEEE 802.15.1), and of receiving and interpreting GPS (Global Positioning System) radionavigation systems.

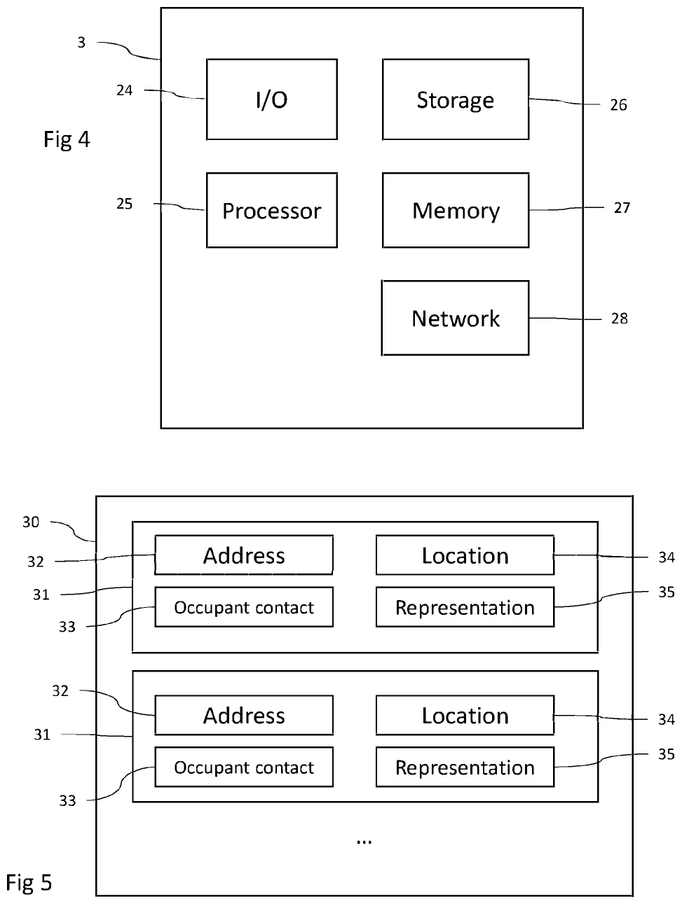

The server 3 will have similar, although not identical functionalities as shown in FIG. 4 of the accompanying drawings. It will have storage 26 (typically a hard disk or solid state drive) and random access memory 27, as well a processor 25 that can process computer code stored in memory 27 or on storage 26. There will be a network controller 28, which will typically be a wired network connection to the Internet 4. Input/output controller 24 controls access to any local peripherals (of which there need not be any in case of “headless” operation).

The server 3 holds a database 30 in the storage 26. The database comprises a plurality of entries 31, each of which relate to one building and will comprise at least:
An address 32 for the building
A location 34 for the building (e.g. latitude and longitude)
Contact details 33 for an occupant associated with the building; and
A parameterised representation 35 of the building (as will be discussed below).

Optionally, the entries could also include the name (service set ID) of any WiFi network associated with the building or accessible from the building, and/or the names of any discoverable Bluetooth devices associated with or accessible from the building.

The occupant terminal would typically have similar functionality to the mobile device 1, and indeed may also be a mobile communication device such as a smartphone as discussed above. Equally well, it could be a dedicated terminal, or, via a web page or application, be able to be run on any suitable computing device, such as a laptop or desktop personal computer.

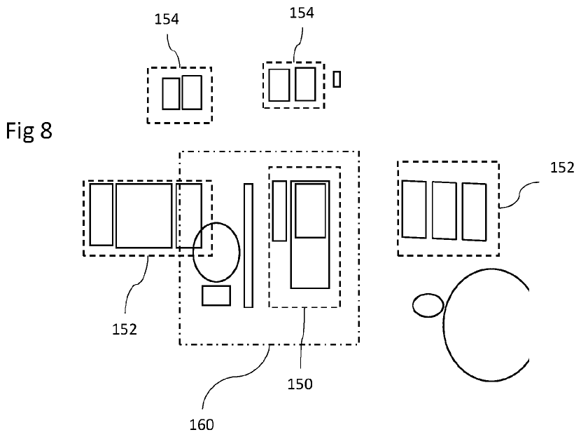

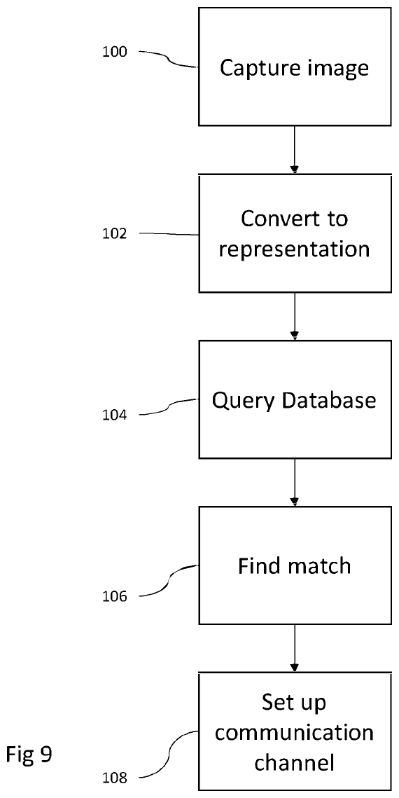

The operation of the system will now be discussed with reference to the flowchart at FIG. 8 of the drawings. Typically, the functionality described below carried out by the mobile device will be implemented through a bespoke application (an “app”), whereas the server will be running a server application.

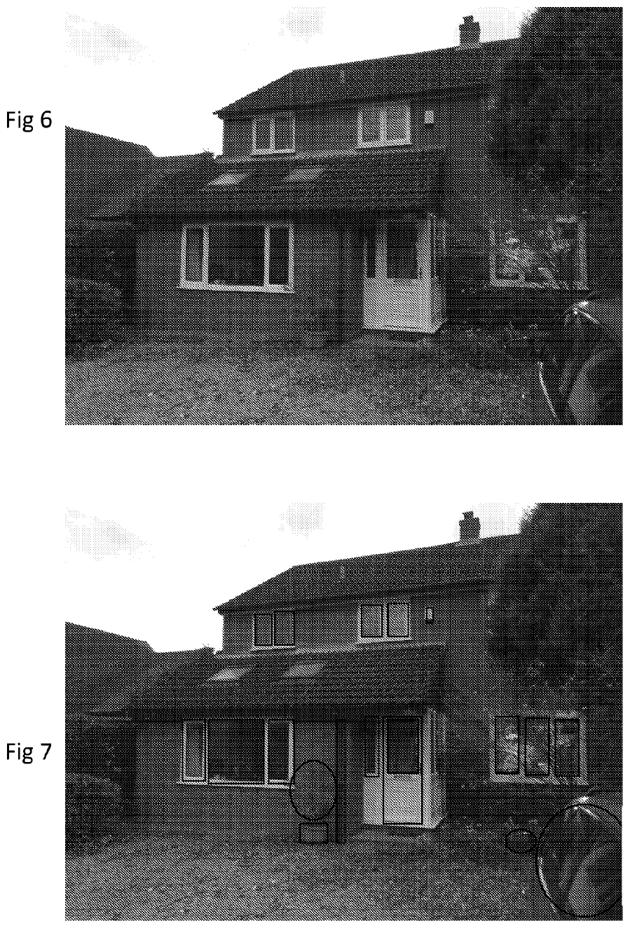

At step 100, a user wanting to get into contact with the occupant of a building (for example, a delivery driver wanting to deliver a package) and having one of the mobile devices 1, captures an image of the building using the camera 11 of the mobile device 1. An example of such a captured image is shown at FIG. 6 of the accompanying drawings.

At step 102, the mobile device 1 converts the captured image into a parameterised representation of the building. Typically, this would involve a first step of edge detection, to determine the most prominent edges in the image, and then pattern matching to determine what those edges represent. A sample of detected edges are shown in FIG. 7 of the accompanying drawings on the captured image, and in FIG. 8 independent of the captured images. Solid lines in these images show the detected edges, with dotted lines being used to indicate features of interest discussed below.

The pattern matching can determine from the detected edges which edges relate to potentially useful features commonly found in buildings. Looking at FIG. 8, group 150 comprising an elongate rectangle containing another rectangle, with a thin rectangle next to it are likely to be a door. The two groups 152 of three adjacent rectangles are likely to be windows, as are the two groups 154 of two rectangles.

The relative spacing of the determined elements (potentially with data relating to colour and so on) potentially including both pattern matched elements and optionally also any other elements detected are then determined to be representation recorded by the mobile device 1

The mobile device 1, at step 104, then constructs a database query based on the determined representation and potentially additional data. The additional data could include:
A location as determined by the network controller 18 from GPS data, including altitude and the compass direction in which the mobile device 1 was pointing when the image was captured
The “names” or Service set ID (SSID) of any Wifi networks available at the location, and/or the names of any Bluetooth devices in discoverable mode at the location, as determined by the network controller 18

The mobile device 1 sends this query to the server 3 over the Internet 4. The server 3 then carries out a search of the database.

Where the GPS location is provided in the query, the database can use that location to limit the search to only those entries 31 that have the location 34 within a threshold distance of the location indicated by the query. This is likely to reduce computation requirements.

The server 3 then determines at step 106 any entries 31 that are a sufficiently close match between the representation in the query and the location 34 stored in the entry 31. Because perfect matches are unlikely, this is likely to involve a determination of a level of correlation between the representations, with matches being indicated only if the correlation is higher than a threshold, or by only returning the match with the highest correlation. The additional data can be used as part of this correlation to add to the correlation with any positive matches.

The server 3 then transmits any successful entries back to the mobile device 1. The mobile device 1 can then (at step 108) use the occupant contact details 33 (e.g. a network address or telephone number) to set up a communication channel. The channel will most likely involve two way audio communication, and potentially video in at least one direction.

In an alternative, the GPS location need not be provided in the query, but an indication can be provided on the screen 10 of whether the match is within a threshold distance of the GPS position measured.

The occupant terminal 2 may be arranged so as to allow the occupant to allow access to the building (e.g. by deactivating an electronic lock or by allowing access to an electronic key safe) or part of the building (for example, opening a parcel receptacle). Thus, if the occupant is absent, they can allow access to acceptable visitors.

Because the image is reduced to a representation and in particular of features and their relative positioning, it does not matter to a great extent where the image is captured. In the example above, whereas the features shown in FIG. 8 have all been detected from a fairly wide view of the building shown in FIG. 6, if the image was captured from a closer viewpoint (e.g. that depicted by selection 160) there will still be sufficient features to determine whether there is a match with any of the entries 31. Likewise, the correlation will take into account that images could be captured from different angles, leading to foreshortening or lengthening of features, but still will some sense of proportion of those features.

Indeed, the representation stored in the database (which may have been generated based on an image or images by the occupant themselves, or by the operator of the database scanning the house, or from third party imaging data, or even from images from other users of the mobile devices 1), may be of the whole of the front of the building, or a more targeted area, such as just the front door. The narrower the area on which the original representation, the more targeted the user of the mobile device 1 must be in capturing the image on which the query is based.

Whereas in this embodiment, the mobile device 1 determines the representation from the captured image, that could equally well be carried out on the server 2 in order to reduce the computational demand on the mobile device 1; as such, the query would then include the captured image itself.

The image captured by the mobile device 1 could be of visible light; for use at night time, the mobile device 1 may be provided with a source of illumination, such as a flash illumination. Alternatively, the mobile device could capture an image using infra-red light, in which case the mobile device may be provided with an infra-red illumination source, or using LIDAR (laser imaging, detection and ranging). In such a case, the representations in the database will typically have been create using the same technology.

The above-mentioned embodiments can be especially useful in the following circumstances:
Particularly where the occupant terminal is arranged to allow the occupant to selectively permit access to the building, in allowing access by the emergency services (for example fire, police or ambulance services),
for passenger transport services wishing to transport an elderly, infirm or otherwise high-risk patient to a medical appointment
Service provision (e.g. cleaning services)
Deliveries of goods
Maintenance providers (e.g. plumbers, especially in case of a plumbing emergency)
Allowing access to a resident who has lost or misplaced their keys (or other access control device)

1. A method of instigating communication between a first party and a second party, the first party having a mobile communication device having mobile connectivity functionality and a camera, comprising:
the mobile communication device capturing at least one image of at least part of a building with the camera;
the mobile communication device querying, using the mobile connectivity functionality, a database of buildings, the database having a plurality of entries, each entry relating to a building and including data relating to the visual appearance of the at least part of the building and contact information for a second party, the querying acting to compare the at least one image of the building with the data relating to the visual appearance of buildings in the database; determining whether the querying results in either at least one match with the visual appearance of buildings in the database or with zero matches; and
if the querying results in at least one match, setting up a communication channel using the mobile telecommunications device to a second party indicated by the at least one match.

2. The method of claim 1, in which the data relating to the visual appearance of the building comprises an image of the building and the querying comprises a comparison of the image of the building captured by the mobile communication device with a comparison the of the image of the building from the data relating to the visual appearance of the building.

3. The method of claim 1, in which the data relating to the visual appearance of the building comprises a representation of visible features of at least part of the building.

4. The method of claim 3, comprising generating, typically using the mobile communication device, a representation of visible features of at least part of the building from the image captured by the mobile communication device.

5. The method of claim 4, in which the querying comprises comparing the representation of visible features from the data relating to the visual appearance of the building and from the captured image.

6. The method of claim 3, in which each representation of visible features represents parametrically the visible features.

7. The method of claim 6, in which the representations of visible features are generated using a feature recognition algorithm on an image of at least part of the building, typically the image captured by the mobile communication device or an image captured for the purpose of generating the data relating to the visual appearance of the building.

8. The method of claim 1, comprising the determination by the mobile communication device of its position, in which each entry in the database includes the position of the building and the querying comprises comparing the position of the mobile communication device with the position of the building in the database.

9. The method of claim 8, in which the querying comprises only carrying out the step of comparing the at least one image of the building with the data relating to the visual appearance of buildings in the database for entries that meet a criterion depending on the position of the mobile communication device.

10. The method of claim 9, in which the criterion is that the distance between the position of the mobile communication device and the position of the building in the database is less than a threshold.

11. The method of claim 1, comprising the mobile communication device sensing local wireless communication networks, in which each entry in the database includes wireless communication networks which can be sensed at the building; the step of querying comprising determining whether there is a match between any sensed local wireless communication networks and the wireless communication networks indicated in the database.

12. A network for instigating communication between a first party and a second party, comprising:
a mobile communication device for the first party and having mobile connectivity functionality and a camera; and
a server holding a database of buildings, the database having a plurality of entries, each entry relating to a building and including data relating to the visual appearance of the at least part of the building and contact information for a second party,
the mobile communication device being connected to the mobile communication device through a communication network;
the mobile communication device being arranged to:
capture at least one image of at least part of a building with the camera;
query, the database over the network so as to compare the at least one image of the building with the data relating to the visual appearance of buildings in the database;
determine whether the querying results in either at least one match with the visual appearance of buildings in the database or with zero matches; and
if the querying results in at least one match, set up a communication channel to a second party indicated by the at least one match.

13. A mobile communication device for instigating communication between a first party and a second party, having mobile connectivity functionality and a camera,
the mobile communication device being able to connect using the mobile connectivity functionality to a server holding a database of buildings, the database having a plurality of entries, each entry relating to a building and including data relating to the visual appearance of the at least part of the building and contact information for a second party,
the mobile communication device being arranged to:
capture at least one image of at least part of a building with the camera;
query, the database over the network so as to compare the at least one image of the building with the data relating to the visual appearance of buildings in the database;
determine whether the querying results in either at least one match with the visual appearance of buildings in the database or with zero matches; and
if the querying results in at least one match, set up a communication channel to a second party indicated by the at least one match.

14. A computer-readable medium carrying computer executable instructions which, when executed on a processor of a mobile communication device, cause it to act as a mobile communication device for instigating communication between a first party and a second party, having mobile connectivity functionality and a camera,
the mobile communication device being able to connect using the mobile connectivity functionality to a server holding a database of buildings, the database having a plurality of entries, each entry relating to a building and including data relating to the visual appearance of the at least part of the building and contact information for a second party,
the mobile communication device being arranged to:
capture at least one image of at least part of a building with the camera;
query, the database over the network so as to compare the at least one image of the building with the data relating to the visual appearance of buildings in the database;
determine whether the querying results in either at least one match with the visual appearance of buildings in the database or with zero matches; and
if the querying results in at least one match, set up a communication channel to a second party indicated by the at least one match.
